(19) United States
(12) Patent Application Publication
(10) Pub. No.: US 2012/0225680 A1
(43) Pub. Date: Sep. 6, 2012

(54) INTERFERENCE COORDINATING METHOD AND CLUSTER, AND METHOD FOR REGISTERING NEW CLUSTER IN HETEROGENEOUS NETWORK

(75) Inventor: Sungjin Suh, Seoul (KR)

(73) Assignee: PANTECH CO., LTD., Seoul (KR)

(21) Appl. No.: 13/508,599

(22) PCT Filed: Nov. 9, 2010
(86) PCT No.: PCT/KR2010/007866

§ 371 Date: May 8, 2012

(30) Foreign Application Priority Data
Nov. 9, 2009 (KR) 10-2009-0107765

(51) Int. Cl. H04B 15/00; H04W 84/02

(52) U.S. Cl. 455/501

(57) ABSTRACT

The present invention relates to a heterogeneous network in which a variety of types of micro or local base stations coexist along with a macro base station.

### CROSS REFERENCE TO RELATED APPLICATIONS

This application is the National Stage Entry of International Application No. PCT/KR2010/007866 filed on Nov. 9, 2010 which claims priority from the benefit of Korean Patent Application No. 10-2009-0107765 filed on Nov. 9, 2009, both of which are herein incorporated by reference for all purposes as if fully set forth herein.

### BACKGROUND

1. Field

The present invention relates to a heterogeneous network in which various types of micro or local stations coexist along with a macro base station.

2. Discussion of the Background

Expected base stations in the future may include a type where various types of micro or local base stations coexist along with a macro base station.

In a wireless communication network environment where different types of communication systems are combined, a large amount of information pieces are efficiently transmitted while signal interference between the different types of communication systems is reduced.

### SUMMARY

An aspect of the present invention is to provide an interference coordinating method in a heterogeneous network, which can reduce interference between different types of wireless communication systems in a wireless communication network environment where the different types of wireless communication systems are combined.

In accordance with an aspect of the present invention to solve the above-mentioned problem, there is provided a method of coordinating interference in a heterogeneous network environment where a first wireless communication network and two or more second wireless communication networks coexist, the two or more second wireless communication networks overlapping with the first wireless communication network and having a type different from that of the first wireless communication network, the method including operating at least a part of the second wireless communication networks as a cluster configured according to a particular standard; and coordinating interference between the second wireless communication networks configuring the cluster according to an interference control scheme different from an interference control scheme used for coordinating interference between the first wireless communication network and a second wireless communication network which does not configure the cluster.

In accordance with another aspect of the present invention, there is provided a cluster for coordinating interference in a heterogeneous network environment where a first wireless communication network and two or more second wireless communication networks coexist, the two or more second wireless communication networks overlapping with the first wireless communication network and having a type different from that of the first wireless communication network, the cluster including at least a part of second wireless communication networks according to a particular standard, wherein the cluster coordinates interference between second wireless communication networks included in the part of the second wireless communication networks according to an interference control scheme different from an interference control scheme used for coordinating interference between the first wireless communication network and a second wireless communication network which is not included in the part of the second wireless communication networks according to the particular standard.

The method and the system disclosed in this specification have an effect of reducing signal interference between different types of wireless communication systems in a wireless communication network environment where the different types of wireless communication systems are combined.

### BRIEF DESCRIPTION OF THE DRAWINGS

FIG. 1 is a diagram illustrating a wireless communication system according to an embodiment of the present invention.

FIG. 2 is a diagram illustrating a wireless communication system in which micro base stations included in a cluster of FIG. 1 correspond to femto cells according to another embodiment of the present invention.

FIG. 3 illustrates a model in which femto cells configure a cluster femto.

FIG. 4 is a flowchart of an inter-cell interference controlling method according to still another embodiment of the present invention.

FIG. 5 is a flowchart of a method of registering a new femto cell in a cluster femto according to yet another embodiment of the present invention.

FIG. 6 is a diagram illustrating a wireless communication system in a case where a new femto cell enters a cluster femto of FIG. 2 according to still yet another of the present invention.

FIGS. 7 and 8 illustrate examples of an ICIC scheme for mitigating interference between a macro base station and a micro or a local base station and a scheme for mitigating interference between femto cells of a cluster femto in a general heterogeneous network when a CSI-RS is transmitted.

FIG. 9 illustrates a case where signal power is controlled to transmit an uplink SRS in a manner of not selecting the macro base station when a coordinated base station set is configured for a coordinated multi-antenna.

### DETAILED DESCRIPTION OF THE ILLUSTRATED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

In this specification, LTE-A (Long Term Evolution-Advanced) is described as an example of a wireless communication network (macro cell) having a wide range of coverage.

Different types of wireless communication networks which overlap with an LTE-A area include a micro/pico/femto cell/relay node network, and the femto cell network is mainly described herein for convenience of the description. However, the present invention is not limited to LTE-A or the femto cell network, and will be described based on a network where different wireless communication networks overlap with each other.

A wireless communication system can be applied to a heterogeneous network including nodes having various RF (Radio Frequency) coverages for a spectral efficiency increase and a cell-coverage extension.

At this time, an example of a configuration of the heterogeneous network includes a type in which the micro/pico/femto cell and the relay node are combined with the macro cell (wide area network).

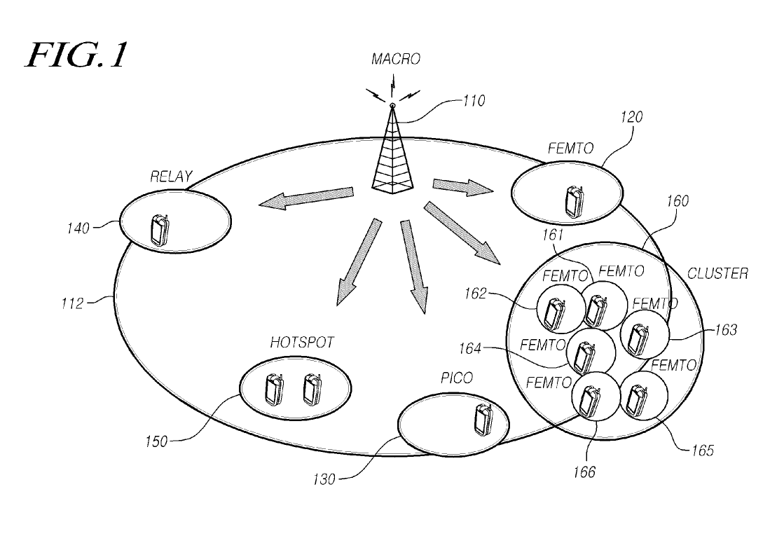

FIG. 1 is a diagram of a wireless communication system according to an embodiment of the present invention.

Referring to FIG. 1, a reference numeral 110 is a macro base station, and a reference numeral 112 is a cell radius or an RF coverage of the macro base station 110. Various types of micro or local base stations such as a femto cell 120, a pico cell 130, a relay 140, and a hot spot 150 coexist within the cell radius 112 of one macro base station 110. Meanwhile, the micro or the local base stations 161 to 166 may configure a cluster 160 within the cell radius 112 of the macro base station 110.

Accordingly, it is required to minimize interference influencing each other in an environment where the various types of micro or local base stations such as the femto cell 120, the pico cell 130, the relay 140, and the hot spot 150 coexist within the cell radius 112 of one macro base station 110.

For example, each base station transmits a reference signal in order to transfer channel information to a user included in a cell of each base station. At this time, the user can grasp a current channel state based on the reference signal transferred from the base station to which the user belongs. If the reference signal transmitted from each base station is distorted due to interference with a reference signal transmitted from another base station, the user cannot exactly know information on the channel and thus the performance is significantly deteriorated. Accordingly, in an environment where base stations having different configurations coexist, the performance deterioration is predicted to be highly serious. Such a signal distortion is generated in a control signal or a data signal as well as the reference signal.

In order to solve the above problem, an ICIC (Inter Cell Interference Coordination) scheme is currently discussed. Among ICIC schemes, there is a scheme of removing interference through a time division. That is, the interference influencing other base stations is removed in such a manner that base stations do not transmit a reference signal in resources in which a particular base station transmits a reference signal. Although such a scheme has a disadvantage of using many more resources to transmit the reference signal in comparison with a conventional scheme, the scheme is frequently used because it can effectively remove the interference.

As another scheme, there is a scheme of removing the interference through a listen-and-transmit technique. In this scheme, a base station detects whether another base station transmits a reference signal by using a predetermined resource. The base station transmits the reference signal by using another resource when the predetermined resource is used, and transmits the reference signal by using the predetermined resource when the predetermined resource is not used. For the scheme, each base station requires a detector for grasping if another base station transmits the reference signal by using the predetermined resource.

There may be various ICIC schemes other than the above two schemes.

The ICIC scheme capable of minimizing interference in the heterogeneous network where the macro and the micro base stations coexist may be applied to all environments in common. However, inventors of the present invention have recognized the need to apply different ICIC schemes optimized under the consideration of a state where base stations coexist instead of to apply the same ICIC scheme capable of minimizing the interference in the heterogeneous network where the macro and micro base stations coexist. Particularly, when the cluster 160 includes the micro or the local base stations 161 to 166, the inventors have recognized that applying the ICIC scheme designed mainly for mitigating interference between a general macro base station and micro base stations is a problem.

Specifically, arrows shown in FIG. 1 indicate that the various types of micro or local base stations such as the femto cell 120, the pico cell 130, the relay 140, and the hot spot 150 within the cell radius 112 of one macro base station 110 receive interference of the macro base station 110. Since power of the various types of micro or local base stations such as the femto cell 120, the pico cell 130, the relay 140, and the hot spot 150 is generally lower than power of the macro base station 110, it is uncommon for the macro base station 110 to receive interference from the micro or the local base stations.

Further, the micro or the local base station is less likely to have another type of micro or local base station within its cell radius as well as it has low power. Accordingly, most ICIC schemes focus on how to mitigate interference from the macro base station 110 by the various types of micro or local base stations such as the femto cell 120, the pico cell 130, the relay 140, and the hot spot 150.

Since the aforementioned ICIC schemes are designed mainly for mitigating interference transmitted from the macro base station 110, the micro base stations 161 to 166 included in the cluster 160 shown in FIG. 1 cannot have a sufficient effect to mitigate interference. That is, since the micro base stations 161 to 166 included in the cluster 160 are installed indoors, a signal transmitted to the macro base station 110 is more preserved in comparison with a case where the micro base stations 161 to 166 are installed outdoors. Accordingly, the micro base stations 161 to 166 included in the cluster are more influenced by interference between the micro base stations 161 to 166 than interference transmitted from the macro base station 110.

In this case, if the ICIC scheme of focusing on mitigating the interference transmitted from the macro base station 110 is directly applied to the micro base stations 161 to 166 included in the cluster 160, the ICIC scheme has no effect.

Hereinafter, a method of minimizing interference between the macro base station and the micro base station or interference in the cluster configured by the micro base stations by separately applying the ICIC scheme for mitigating the interference between the macro base station and the micro base station and the ICIC scheme for mitigating the interference between the micro base stations included in the cluster under the consideration of each feature will be described.

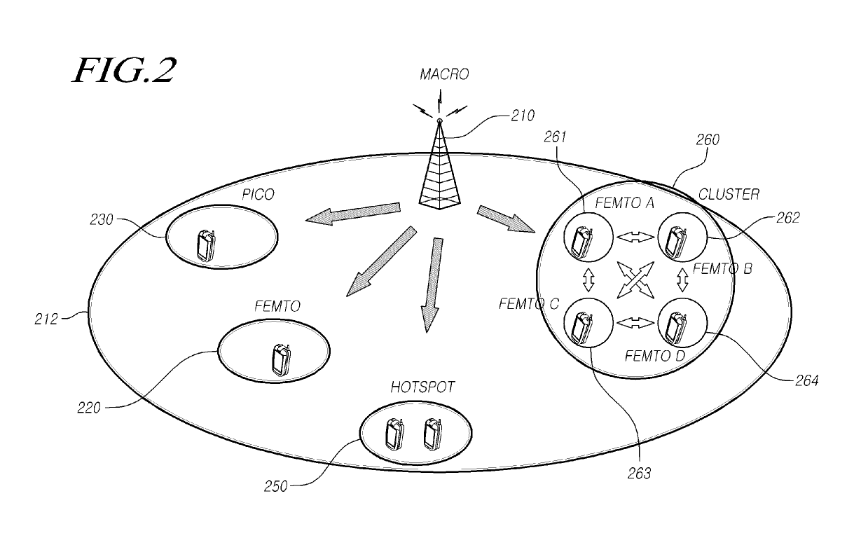

FIG. 2 is a diagram of a wireless communication system in which the micro base stations included in the cluster of FIG. 1 are femto cells according to another embodiment of the present invention.

Referring to FIG. 2, a reference numeral 210 is a macro base station, and a reference numeral 212 is a cell radius or an RF coverage of the macro base station 210. Various types of micro or local base stations such as a femto cell 220, a pico cell 230, a relay (not shown), and a hot spot 250 coexist within the cell radius 212 of one macro base station 210. Meanwhile, femto cells 216 to 266 as the micro or local base stations may configure a cluster femto 260 within the cell radius 212 of the macro base station 210. The cluster femto 260 refers to a type of cluster including femto cells as a plurality of micro or local base stations.

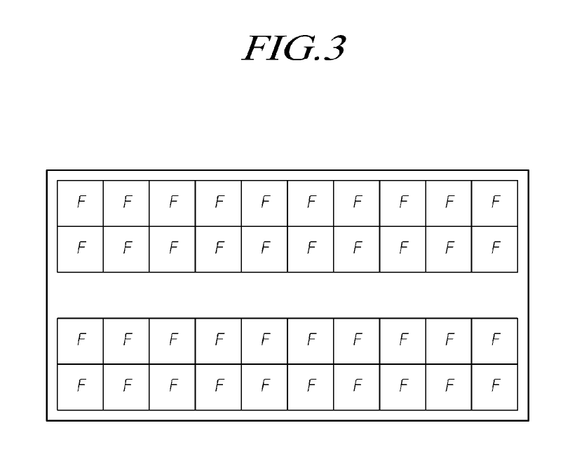

FIG. 3 illustrates a model in which femto cells configure a cluster femto.

Referring to FIG. 3, although only four femto cells included in the cluster femto 260 are illustrated in FIG. 2, the number of femto cells included in the cluster femto 260 is not limited as shown in FIG. 3.

The femto cells 261 to 264 of FIG. 2 or FIG. 3 included in the cluster femto 260 can be installed in an indoor building such as an office or an apartment. The femto cells 261 to 264 of FIG. 2 or FIG. 3 can provide more users with a data service in a higher level while solving a service problem generated in an indoor propagation shadow area.

At this time, when the femto cells 261 to 264 configure the cluster 260, interference between the femto cells 261 to 264 included in the cluster 260 plays a bigger part than interference transmitted from the macro base station 210.

Accordingly, when the same ICIC scheme for minimizing interference transmitted from the macro base station 210 in the heterogeneous network where the macro base station 210 and the micro or the local base stations coexist is applied to the femto cells 261 to 264 included in the cluster femto 260, the cluster femto 260 has difficulty obtaining an interference mitigating effect due to larger interference between the femto cells 261 to 264.

Therefore, when the micro or the local base stations included in the cluster are femto cells 261 to 264, an ICIC scheme for effectively mitigating the interference generated in the femto cluster 260, in which the interference between the femto cells 261 to 264 is larger than the interference transmitted from the macro base station 210, is applied to the cluster femto 260 instead of applying the ICIC scheme of considering only the interference transmitted from the macro base station 210. That is, the ICIC scheme applied to the cluster femto 260 is differentiated from the ICIC scheme of mainly considering only a one-to-one relation between the general macro base station and the micro or the local base station.

At this time, the ICIC schemes used in the heterogeneous network include various methods. An actual coordination method can mitigate interference by using an interference control scheme, a scheduling scheme, a beam forming scheme, etc. Further, an indirect method may include a scheme of selecting a cell, which little interference enters, through a cell selection or a cell association, or a scheme of overcoming an influence generated due to the interference by receiving all data from two or more cells. Alternatively, the interference can be mitigated by controlling a cell load balance and the interference can be mitigated through a control for each link or a power control.

For example, in general, the interference control scheme is used as the ICIC scheme for minimizing the interference transmitted from the macro base station 210 and the scheduling scheme is used as the ICIC scheme for effectively mitigating the interference in the cluster femto 260 in which the interference between the femto cell 261 to 264 is larger in the heterogeneous network where the macro base station 210 and the micro or the local base station coexist.

Hereinafter, a standard and a method for configuring the cluster femto 260 in the heterogeneous environment will be described. First, the method of a different ICIC scheme optimized for the cluster femto cells or the cluster femto according to the standard for the member of the cluster femto will be described.

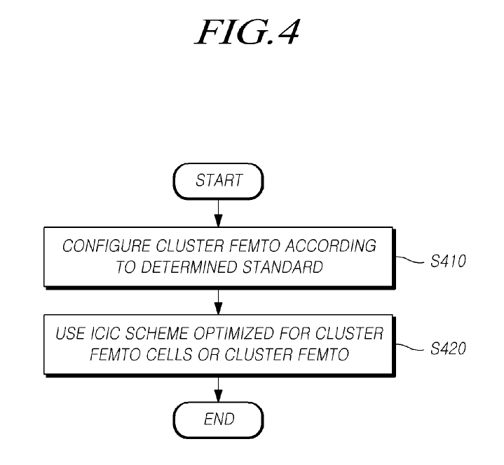

FIG. 4 is a flowchart of an inter-cell interference controlling method according to another embodiment of the present invention.

One or a plurality of femto cells 261 to 264 first configures the cluster femto 260 in step S410.

The standard for the member of the cluster femto 260 may be determined in various aspects but the present invention is not limited thereto.

First, in a case of the cluster femto 260 configured by a fixed owner, the femto cells 261 to 264 concentrated in a particular range can be passively set as the cluster by the owner. For example, femto cells having the same Closed Subscriber Group Identity (CSG ID) of the femto cells can be operated as the cluster femto 260. At this time, a Closed Subscriber Group (CSG) refers to a femto cell or a base station group located or installed within the cell radius 212 of the macro base station 210. The CSG ID refers to an ID for identifying the CSG.

Second, a femto cell existing in a particular network working group can configures the cluster. Such a femto cell has a feature of being connected to a LAN, and can configure the cluster by grouping femto cells belonging to a predetermined group specified by the same network working group or the same level IP (Internet Protocol) since the femto cell is assigned an IP to be operated.

For example, when femto cells installed in adjacent positions are connected to the LAN, they can be assigned IPs in the same level (e.g. 128.20.20.1 and 128.20.20.4 or 208.20.19.1 and 208.20.17.8). In this case, the femto cells 261 to 264 of FIG. 2, which are assigned the IPs in the same level and located within the cell radius 212 of the macro base station 210, can configure the cluster femto 260. Since the femto cell 220 shown in FIG. 2 has an IP in a different level from the level of the femto cells 261 to 264 included in the cluster 260, the femto cell 220 does not correspond to the cluster femto 260.

At this time, the femto cells 261 to 264, which have the IPs in the same level to configure the cluster femto 260, can have the aforementioned same CSG ID, but some of the femto cells 261 to 264 can have a different CSG ID. For example, when two companies install femto cells in the same office building, respectively, and configure different CSGs from each other, the femto cells of the two companies can configure the cluster femto in a case where the femto cells use IPs in the same level.

Third, femto cells in which signals having an intensity larger than a threshold are measured and detected can be operated and configured as the cluster. When the femto cells configure the cluster based on the signal intensity, the cluster can be most directly configured. An example of such a signal intensity may include a signal-to-noise ratio, a signal-to-interference ratio and the like.

The standard for the member of the cluster femto 260 is not limited to the aforementioned three standards. For example, when the femto cells 261 to 264 have a GPS mounted therein or the femto cells 261 to 264 can identify their positions even though not having the GPS, femto cells located adjacently to each other can be configured as the cluster femto.

The standard by which the femto cells 261 to 264 configure the cluster femto 260 can be determined by selecting one or a plurality of aforementioned manners.

Next, in a case of the femto cells 261 to 264 satisfying the determined standard to configure the cluster femto 260, the ICIC scheme differentiated from the ICIC scheme used in the general femto cell 220 of FIG. 2 is used in the cluster femto cells or the cluster femto in step S420.

As described above, in general, the ICIC scheme for minimizing the interference transmitted from the macro base station 210 may be applied in the heterogeneous network environment where the macro base station 210 and the micro or the local base station coexist and the ICIC scheme for effectively mitigating the interference between the femto cells 261 to 264 is applied in the cluster femto 260 having larger interference between the femto cells 261 to 264.

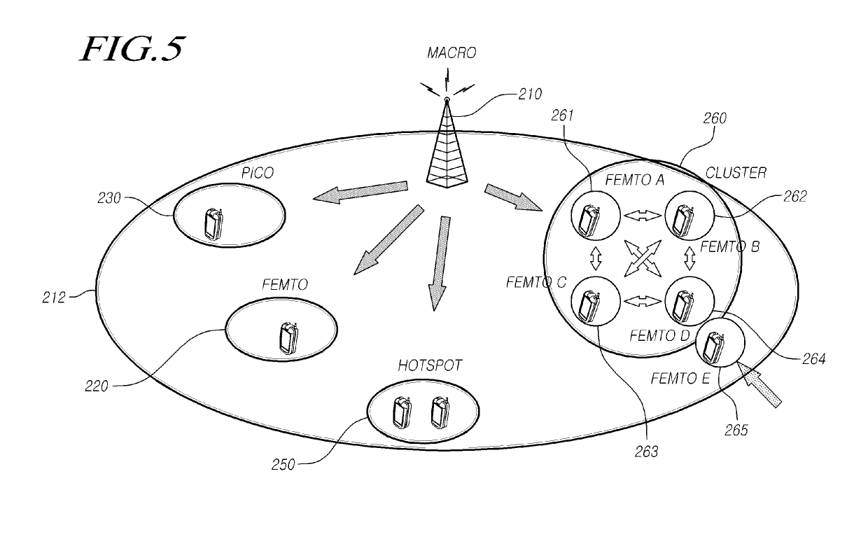

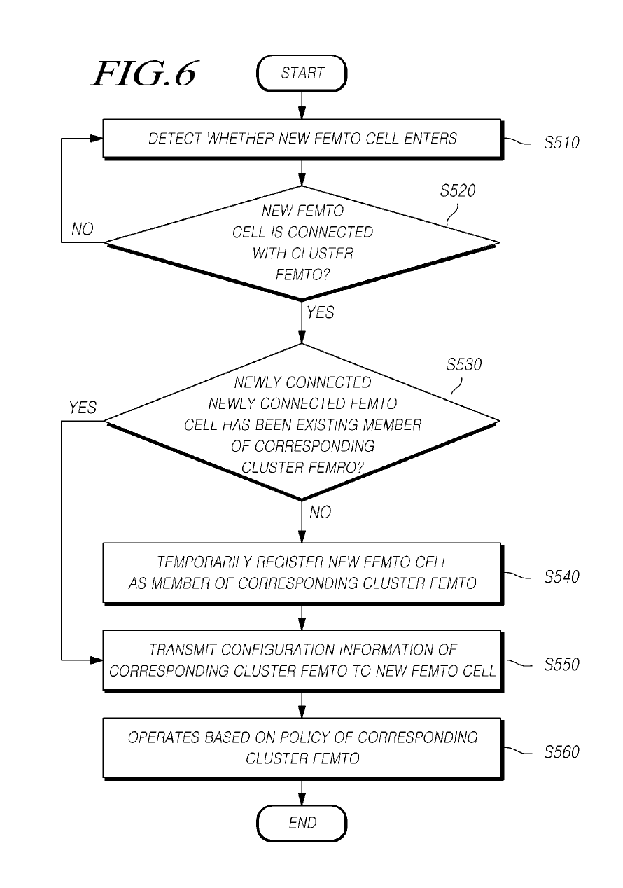

FIG. 5 is a flowchart of a method of registering a new femto cell in a cluster femto according to still another embodiment of the present invention. FIG. 6 is a diagram of a wireless communication system when a new femto cell enters the cluster femto of FIG. 2 according to yet another embodiment of the present invention. Reference numerals of FIG. 6 are equal to those of FIG. 2, but only a reference numeral of 265 of the femto cell newly entered the cluster femto is added.

Referring to FIGS. 5 and 6, it is determined whether the new femto cell 265 enters the cluster femto 260 in a state where the femto cells 261 to 264 described with reference to FIG. 4 configure the cluster femto 260 based on the determined standard in step S510. At this time, the new femto 265 having entered the cluster femto 260 is newly installed within the cell radius 212 of the macro base station 210 or the femto cell 220, which has existed within the cell radius 212 of the macro base station 210 but does not correspond to the cluster femto 260, can enter the cluster femto 260.

Next, it is determined whether the new femto cell 265 is connected with the cluster femto 260 in step S520. When the new femto cell 265 is not connected with the cluster femto 260, it is continuously determined whether the new femto cell 265 of step S510 enters the cluster femto 260.

On the other hand, when the new femto cell 265 is connected with the cluster femto 260, it is determined whether the connected femto cell 265 has been an existing member of the corresponding cluster femto 260 in step S530.

When it is determined that the newly connected femto cell 265 has not been the existing member of the corresponding cluster femto 260 in step S530, the new femto cell 265 is temporarily registered as the member of the corresponding femto cell 260 in step S540.

When it is determined that the newly connected femto cell 265 has been the existing member of the corresponding cluster femto 260 in step S530, configuration information of the corresponding cluster femto 260 is transmitted to the femto cell 265 in step S550.

The femto cell 265, which has been newly registered as the member of the corresponding cluster femto 260 in step S550 or has received the configuration information of the corresponding cluster femto 260, is operated according to a policy of the corresponding cluster femto 260 described with reference to FIG. 4 in step S560.

As described above, the femto cells 261 to 264 configuring the cluster femto 260 use the ICIC scheme suitable for a cluster environment. Accordingly, if the general external femto cell 265 enters the cluster femto 260 and uses a different ICIC scheme instead of the ICIC scheme used in the corresponding cluster femto 260, a signal of the newly entered femto cell 265 may act as large interference to the femto cells 261 to 264 configuring the cluster femto 260.

Accordingly, as described above, in a case of the femto cell 265, the ICIC scheme used in the cluster femto 260 is applied without the need of temporarily registering the femto cell 265 in the cluster femto 260 when the femto cell 265 is the existing member of the cluster femto 260, but the ICIC scheme used in the cluster femto 260 is applied after temporarily registering the femto cell 265 as the member of the cluster femto 260 when the femto cell 265 is not the existing member of the cluster femto 260.

Meanwhile, when information related to operations of embodiments of the present invention, which has been described above or will be described later, such as the interference control scheme of the macro base station 210, the micro base stations 220, 230, and 250, and the cluster femto 260, the cluster standard, or the configuration information of the femto is transmitted or received between the macro base station 210, the micro base stations 220, 230, and 250, and the cluster femto 260, a general physical layer or a higher layer of the physical layer can be used, and a separate RRC (Radio Resource Control) signaling can be used. The information related to the operations of embodiments of the present invention, which has been described above or will be described later, such as the interference control scheme of the macro base station 210, the micro base stations 220, 230, and 250, and the cluster femto 260, the cluster standard, or the configuration information of the femto can be periodically or aperiodically provided to the micro base stations 220, 230, and 250 or the cluster femto 260 by the macro base station 210, or provided by the macro base station 210 according to a request of the micro base stations 220, 230, and 250 or the cluster femto 260. A cycle of the information related to the aforementioned operations, which is periodically provided by the macro base station 210, may be constant or altered according to an environment change when the information is renewed.

Hereinafter, a CSI-RS and an SRS are described as an example of a reference signal, a control signal, or a data signal generating a signal distortion in the heterogeneous network, and an embodiment in which the ICIC scheme for mitigating the interference between the macro base station and the micro or the local base station is applied and the ICIC scheme for mitigating the interference the femto cells of the cluster femto is applied will be described in detail.

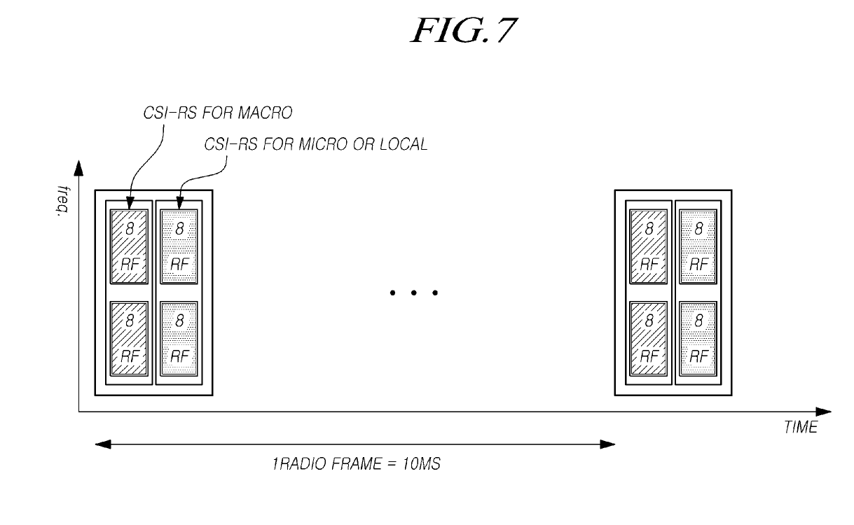

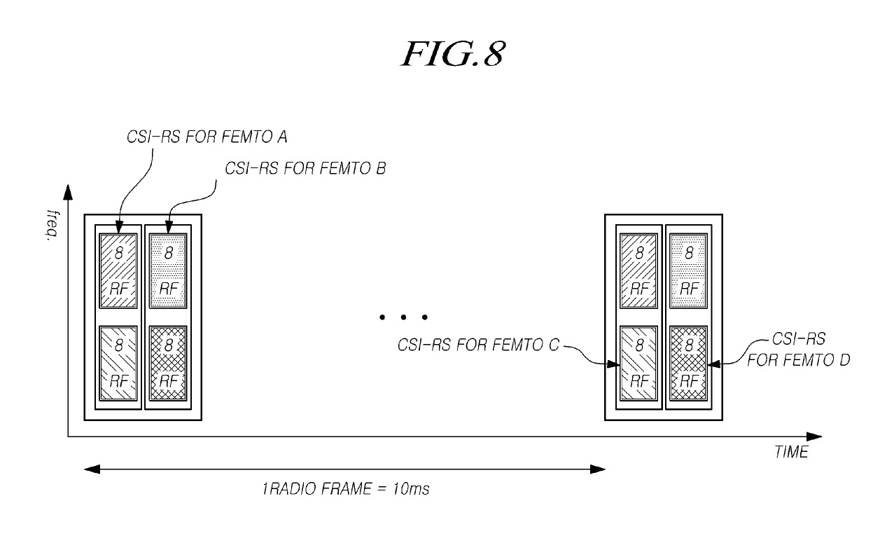

FIGS. 7 and 8 illustrate an example of the ICIC scheme for mitigating the interference between the macro base station (which is not included in the cluster) and the micro or the local base station and an example of the ICIC scheme for mitigating the interference between the femto cells of the cluster femto in the general heterogeneous network when the CSI-RS is transmitted.

The number of REs (Resource Elements) transmitting CSI-RSs (Channel Status Information-Reference Signals) may be 8, 16, or 32 per one radio frame. The CSI-RS is a type of reference signal transmitted to a user from a base station to perform a channel estimation with channel status information. Further, the RE is a unit of one subcarrier transmitting one symbol in an OFDMA wireless communication system.

Basic channel information can be acquired when a minimum of eight REs are used. When 16 or 32 REs are used, overheads may be increased but a more reliable RS can be transmitted or ICIC schemes for mitigating interference can be used.

Referring to FIGS. 2 and 7, when every one radio frame uses 32 REs, 16 REs of the 32 REs are used for transmitting the CSI-RS by the macro base station, and the remaining 16 REs may be used by various types of micro or local base stations such as the femto cell 220, the pico cell 230, the relay (not shown), and the hot spot 250 within the cell radius 212 of one macro base station 210.

Since the micro or the local base stations have low transmission power and low proximity, they do not cause a big interference problem even though they use 16 REs of the same resource. However, when a CSI-RS transmitting method used in FIG. 7 is directly applied to the cluster femto 260, big interference may be generated when the plurality of femto cells 260 to 264 use the same 16 REs since the femto cells 260 to 264 are concentrated in the cluster femto 260.

FIG. 8 illustrates a CSI-RS transmitting method in which the four femto cells 261 to 264 in an environment of the cluster femto 260 of FIG. 2 use eight REs, respectively so that the interference may be mitigated.

As another method, the CSI-RS may not be transmitted in a femto cell in which a user is connected but does not receive a service since a channel estimation is not required in the femto cell, and the CSI-RS may be transmitted only in a femto cell in which the user is connected and thus the channel estimation is required, the femto cells being included in the cluster femto 260.

As still another method, for a band having large interference, the CSI-RS having high power may be transmitted by controlling power used for the CSI-RS transmission. Alternatively, the CSI-RS may be transmitted through optimum 8 REs autonomously selected by each femto cell among the four groups of eight REs.

To sum it up with reference to FIGS. 2, 7, and 8, when every one radio frame uses 32 REs, 16 REs of the 32 REs are used for transmitting the CSI-RS by the macro base station, and the remaining 16 REs may be used by various types of micro or local base stations such as the femto cell 220, the pico cell 230, the relay (not shown), and the hot spot 250 within the cell radius 212 of one macro base station 210.

Meanwhile, an ICIC scheme differentiated from the ICIC scheme used between the macro base station and the micro or the local base station can be used in an environment of the cluster femto 260. That is, the ICIC scheme transmits the CSI-RS for mitigating interference through using eight REs by the four femto cells 261 to 264, respectively.

Accordingly, when the ICIC scheme different from the ICIC scheme applied to the macro base station and the micro or the local base station is used in the cluster femto 260, an excellent effect for the interference mitigation may be obtained.

Meanwhile, a coordinated multi-antenna service can be provided by configuring a coordinated base station within the heterogeneous network. At this time, the coordinated multi-antenna service refers to a service of transmitting a signal cooperatively with a plurality of base stations to one user. The plurality of base stations can simultaneously transmit the signal, or the signal can be transmitted by a selected base station having the best channel status or through a beam forming.

The importance for an uplink SRS is increasing to perform such a coordinated multi-antenna service. A characteristic of a downlink channel can be grasped using a channel state of an uplink channel through reciprocity properties of channels, and overheads of a downlink feedback for the coordinated multi-antenna service can be significantly reduced.

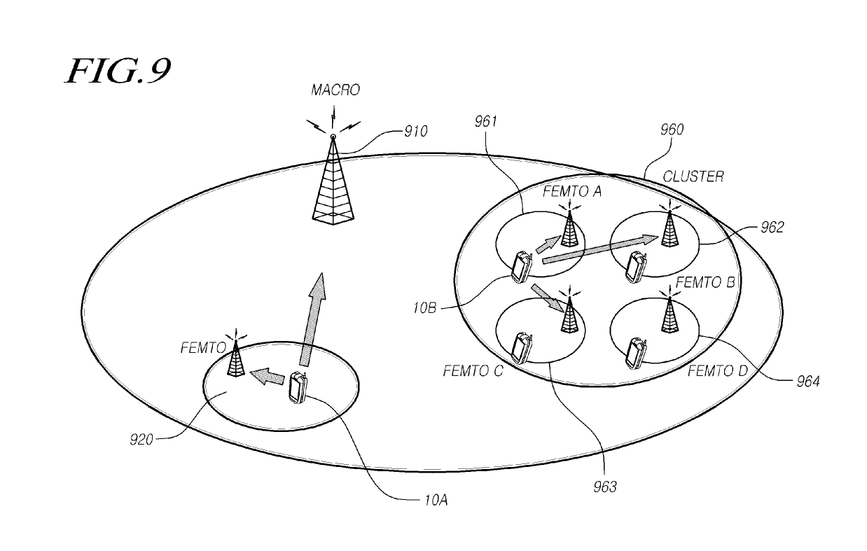

FIG. 9 illustrates a case where signal power is controlled to transmit an uplink SRS in a manner of not selecting the macro base station when the coordinated base station set is configured for the coordinated multi-antenna.

Referring to FIG. 9, when the uplink SRS is transmitted for the coordinated multi-antenna service, a user of the general femto cell 920 can perform the coordinated multi-antenna service by configuring the macro base station 910 as the coordinated base station set. The general micro or local base station is likely to configure the coordinated base station set with the macro base station 310 in order to perform the coordinated multi-antenna service.

However, when a user of the cluster femto 960 configures the coordinated base station set with the macro base station 910 for the coordinated multi-antenna service, difference of transmission/reception power between the macro base station 910 and the micro or the local base station may be a hundredfold or more. Accordingly, although the ICIC scheme is used, it may be difficult to effectively mitigate the interference and also it may be impossible to perform the coordinated multi-antenna service according to cases.

Accordingly, the user of the cluster femto 960 can adopt a method of not selecting the macro base station 910 when the user of the cluster femto configures the coordinated base station set for the coordinated multi-antenna. FIG. 9 illustrates a case of controlling signal power to transmit the uplink SRS through the method.

A user terminal 10B of the cluster femto 960 can transmit the uplink SRS with lower signal power since the user terminal 10B does not consider the coordinated multi-antenna service from the macro base station 210.

The aforementioned embodiments can obtain a more effective interference mitigating effect by differentiating the ICIC schemes used in the heterogeneous network, the ICIC schemes including the scheme used between the general macro base station and the micro or the local base station and the scheme used for mitigating interference between the cluster femto.

Although the embodiments of the present invention have been described with reference to the drawings, the present invention is not limited thereto.

For example, it has been described that the interference between the cluster femto is coordinated according to the interference control scheme used between the general macro base station and the micro or the local base station and a different interference control scheme. However, the interference between the general macro base station and the micro or the local base station may be coordinated according to the same interference control scheme as that between the cluster femto after the interference between the second wireless communication networks configuring the cluster is coordinated or while the interference between the cluster femto is coordinated according to the different interference control scheme from that used between the general macro base station and the micro or the local base station.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

1. A method of coordinating interference in a heterogeneous network environment where a first wireless communication network and two or more second wireless communication networks coexist, the two or more second wireless communication networks overlapping with the first wireless communication network and having a type different from that of the first wireless communication network, the method comprising:
operating at least a part of the second wireless communication networks as a cluster configured according to a particular standard; and
coordinating interference between the second wireless communication networks configuring the cluster according to an interference control scheme different from an interference control scheme used for coordinating interference between the first wireless communication network and a second wireless communication network which does not configure the cluster.

2. The method as claimed in claim 1, wherein the particular standard comprises at least one of whether closed Subscriber Group Identities (CSG IDs) are equal, whether IP (Inter Protocols) levels are equal, or whether signal intensities are equal to or larger than a threshold.

3. The method as claimed in claim 1, wherein the first wireless communication network is a macro base station, and the second wireless communication network is at least one of a femto cell, a pico cell, a relay, and a hot spot.

4. The method as claimed in claim 3, wherein the second wireless communication network includes at least one femto cell, and the second wireless communication network configuring the cluster is the femto cell.

5. The method as claimed in claim 1, wherein the interference control scheme comprises at least one of an interference control, a scheduling, a beam forming, a cell selection, a cell association, a cell load balance control, a control for each link, and a power control.

6. The method as claimed in claim 1, wherein operating of at least the part of the second wireless communication networks as the cluster comprises, when a new second wireless communication network conforms to the particular standard of the cluster, adding the new second wireless communication network to the cluster.

7. The method as claimed in claim 1, wherein coordinating of the interference between the second wireless communication networks comprises coordinating at least one interference of a reference signal, a control signal, and a data signal generating a signal distortion in the heterogeneous network.

8. The method as claimed in claim 1, wherein coordinating of the interference between the second wireless communication networks comprises, when a user terminal of the cluster configures a coordinated base station set for a coordinated multi-antenna service, not configuring the coordinated base station set with the first wireless communication network.

9. The method as claimed in claim 1, further comprising coordinating interference between the first wireless communication network and the second wireless communication network which does not configure the cluster according to the interference control scheme equal to the interference control scheme used for coordinating the interference between the second wireless communication networks configuring the cluster after coordinating of the interference between the second wireless communication networks configuring the cluster.

10. A cluster for coordinating interference in a heterogeneous network environment where a first wireless communication network and two or more second wireless communication networks coexist, the two or more second wireless communication networks overlapping with the first wireless communication network and having a type different from that of the first wireless communication network, the cluster comprising:
at least a part of second wireless communication networks according to a particular standard,
wherein the cluster coordinates interference between second wireless communication networks included in the part of the second wireless communication networks according to an interference control scheme different from an interference control scheme used for coordinating interference between the first wireless communication network and a second wireless communication network which is not included in the part of the second wireless communication networks according to the particular standard.

11. The cluster as claimed in claim 10, wherein the particular standard comprises at least one of whether closed Subscriber Group Identities (CSG IDs) are equal, whether IP (Inter Protocols) levels are equal, or whether signal intensities are equal to or larger than a threshold.

12. The cluster as claimed in claim 10, wherein the first wireless communication network is a macro base station, and the second wireless communication network is at least one of a femto cell, a pico cell, a relay, and a hot spot.

13. The cluster as claimed in claim 12, wherein the second wireless communication network includes at least one femto cell, and the second wireless communication network configuring the cluster is the femto cell.

14. The cluster as claimed in claim 10, wherein the interference control scheme comprises at least one of an interference control, a scheduling, a beam forming, a cell selection, a cell association, a cell load balance control, a control for each link, and a power control.

15. The cluster as claimed in claim 10, wherein the controlled interference between the second wireless communication networks comprises at least one interference of a reference signal, a control signal, and a data signal generating a signal distortion in a heterogeneous network.

16. A method of newly registering a cluster in a heterogeneous network environment where a first wireless communication network and two or more second wireless communication networks coexist, the two or more second wireless communication networks overlapping with the first wireless communication network and having a different type from that of the first wireless communication network, the method comprising:
detecting whether a new second wireless communication network enters the cluster in a state where a part of the second wireless communication networks configures the cluster according to a particular standard;
determining whether the new second wireless communication network has been a member of the cluster,
transmitting configuration information of the cluster to the new second wireless communication network when the new second wireless communication network has been the member of the cluster, and temporarily registering the new second wireless communication network as the member of the cluster when the new second wireless communication network has not been the member of the cluster; and
coordinating interference between the second wireless communication networks configuring the cluster according to an interference control scheme different from an interference control scheme used for coordinating interference between the first wireless communication network and a second wireless communication network which does not configure the cluster.

17. The method as claimed in claim 16, wherein the first wireless communication network is a macro base station, and the second wireless communication network is at least one of a femto cell, a pico cell, a relay, and a hot spot.

18. The method as claimed in claim 17, wherein the second wireless communication network includes at least one femto cell, and the second wireless communication network configuring the cluster is the femto cell.
